(19) United States
(12) Patent Application Publication
(10) Pub. No.: US 2016/0224941 A1
(43) Pub. Date: Aug. 4, 2016

(54) Candidate Fit Engine - a system that finds competitive candidates and ranks the fit level of each candidate to the position's requirements

(71) Applicants: Yalon Roterman, Yokneam llit (IL); Orit Roterman, Yokneam llit (IL)

(72) Inventors: Yalon Roterman, Yokneam llit (IL); Orit Roterman, Yokneam llit (IL)

(73) Assignee: JobFit LTD, Yokneam IIit (IL)

(21) Appl. No.: 15/006,149

(22) Filed: Jan. 26, 2016

Related U.S. Application Data
(60) Provisional application No. 62/110,469, filed on Jan. 31, 2015.
(60) Provisional application No. 62/110,470, filed on Jan. 31, 2015.

(51) Int. Cl. G06Q 10/10

(52) U.S. Cl. CPC G06Q 10/1053

(57) ABSTRACT

This invention relates to a Fit Engine solution for sourcing candidates to relevant positions which provides immediate and automatic matching of the right candidate to the right position in the right company; wherein the company defines the parameters for a specific position, the candidate enters his profile that includes his desires and his skills, the data is analyzed and sorted by the Fit Filter and the Fit Algorithm and the application provides a ranked and stored list of the most relevant Candidates. The candidate's information is available to each position, at any time it is published and the candidate can be available to a position that is already published and to positions that will be published in the future without any intervention from the candidate. Because a link is established between the candidate, the company and the desired role, when a new position is opened the application knows that the candidate already approved to be applied to this company and to the new position and he is immediately applied to the position without the ongoing effort of the candidate to search for new positions.

The present invention relates to a method of sourcing and talent management solution using a web application. More particularly, this invention relates to an algorithm that finds and ranks adequate candidates for each position in each company based on the specifications of the position and the skills and desires of the candidates.

### BACKGROUND OF THE INVENTION

The main asset of each company is the employees, companies that succeed to match the skills and capabilities of its employees with the requirements of each position and the company's culture will have more chance to succeed. Right now companies and Placement Companies waste a lot of time and resources in finding the right candidate to the right company and to the right position. The recruiter needs to go over a long list of candidates that may not be relevant, and may not have all the relevant information he needs to match the right candidate to the most suitable position. The recruiter needs to sort many applicants, some of them are not relevant or duplicated, and select the ones that fit the specific position. Afterward the recruiter usually interviews the relevant candidates in order to find the right match. On the other hand, the candidate needs to track the position lists, on a daily basis to find out if new positions were added and submit his/her resume one by one. This procedure takes a long time from the moment the candidate sends his resume to placement companies until this data is delivered to the company and the recruiter assess the potential of the candidate. This makes the work inefficient and may result in cases were the recruiter, despite his experience, will not match the most skilled person to the job.

Therefore there is a need for a solution that will provide the company and the candidate with the relevant data immediately, sort and rank the candidates according to their fit with each specific requirement in the position and find competitive candidates that match the company's profile.

### BRIEF DESCRIPTION OF THE INVENTION

This invention is a web solution for matching the right candidate to the right position in a company without the mediation of Placement Companies. There is no need for the placement process where the recruiter needs to sort many applicants and select the ones that fit the specific position. This application made the regular placement process unnecessary and turns it into a very easy and fast process. This solution provides the company for each specific position, according to their specific requirements, the data they need, immediately, and sorts the candidates according to the relevancy to the specified position and company profile. On the other hand, the candidate can select once his desired positions and desired companies and since then, he is automatically submitted to his selected positions whenever they are available, without the need for monitoring the available positions on a daily basis.

The present invention relates to a method of sourcing and talent management solution using a web application. More specific, this application relates to the placement of employees that fits the companies need. More particularly, this invention relates to an algorithm that finds and ranks adequate candidates for each position in each company based on the specification of the position and the skills and desires of the candidate.

The term “company” or “companies” or “Placement Companies” or “Placement Company” of this application, as used herein, refers to any public or private employer that has one or more office address, but can also be a recruiting company that represents several employers.

The term “role” or “roles” as used herein, refers to all the types of occupations that are available in the company, this list will include roles that are filled, but may be available and roles that the company is looking for a new candidate—a position.

The term “position” as used herein refers to an open role in which the company is looking for a candidate.

In one embodiment, this invention relates to a method which provides a management solution of sourcing candidate.

In another embodiment, this invention relates to an algorithm that finds and ranks competitive candidates for each position in each company based on the specification of the position and the skills and desires of the candidate.

In another embodiment, the present invention relates to the placement of employees that fits the companies need. More particularly, this invention relates to an algorithm that enables candidates to select in a specific company, a specific role, and find out if there is a fit between what the candidate desire and the company's needs.

In another embodiment, this invention relate to the way candidates are submitted to discreet positions without the mediation of head hunters or placement companies.

In another embodiment, this invention relates to graphic interface of the fit level for the parameters defined for the specific position.

This application establish a link between the candidate and the company that enables the candidate to be available automatically to all positions the candidate specified as relevant for him/her—meaning that a candidate will be available to a position that is already published and to positions that will be published in the future without any intervention from the candidate.

### DESCRIPTION OF THE DRAWINGS

FIG. 1—describes the fit process and the algorithms that finds and ranks adequate candidates for each position.

FIG. 2—describes an example of the algorithm's outcome that includes a quantitative fit value for all candidates that were applied to the position.

FIG. 3—describes a company selection user interface map.

FIG. 4a describes an example of a graphic view of the Fit level for Years of Experience as defined for the specific position.

FIG. 4b describes an example of a graphic view of the Fit level for distance as defined for the specific position.

FIG. 4c describes an example of a graphic view of the Fit Level for level of seniority as defined for the specific position.

FIG. 4d describes an example of a graphic view of the Fit level for Education as defined for the specific position.

FIG. 4e describes an example of a graphic view of the Fit level for Languages as defined for the specific position.

### DETAILED DESCRIPTION OF THE INVENTION

During registration of a company or a candidate for the Fit Engine application, several parameters are defined—the company's profile and the candidate's profile.

The company's profile includes a list of relevant roles and the address of each office in the company. The list of roles is a list of all the types of occupations that are available in the company, this list will include roles that are filled and roles that the company is looking for a new candidate—a position. The company saves this information as part of the company's profile.

The set of roles can be composed of field and a related sub-field, for example:

| Field | Sub Field |
|---|---|
| SW | C |
| SW | Real Time |
| HW | DSP |
| HR | Recruiter |

The set of roles can be modified if a new role is added to the company, for example the company opened a new IT department with helpdesk support, in this case a field-IT and subfield-helpdesk will be added to the list of roles. A role can also be removed from the company list of roles.

The candidate's profile includes his desires and his skills, this profile is saved to the database during registration to the system or when the candidate edits and saves his profile. The candidate's desires can include, for example, the role or roles the candidate is looking for, the search radius around his home address, the job type and extent and level of seniority he is looking for. The candidate's skills can include, for example, his years of experience in a specific role, his education and other attributes that can help rank the relevancy of the candidate to a specific position.

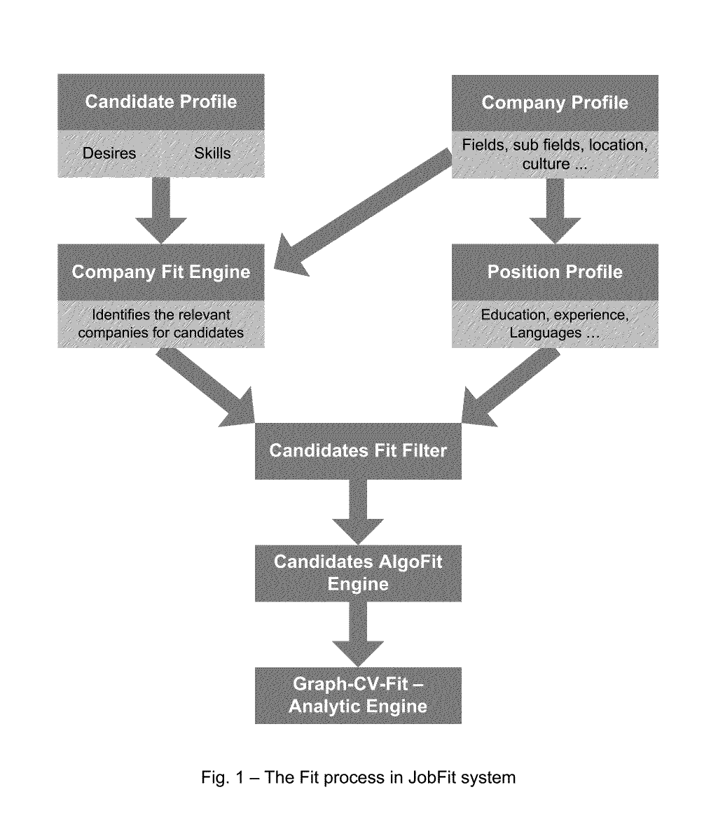

The desired role or roles of the candidate and the search radius around the home address from the candidate's profile, for example, are used by The Company Fit Engine to create a list of all the relevant companies that have the roles the candidate specified and are within the search radius from his home address, as illustrated in the first step of FIG. 1. From this list the candidate selects the companies he would like to be applied to, and he is than linked to those companies in the database. This link enables immediate submission of the candidate to relevant positions in the selected companies, once they are published or modified or when the candidate profile is saved, without the mediation of the placement companies or head hunters.

As illustrated in FIG. 1, the next steps—calculation of the fit level can be triggered by either an event of a candidate's profile being saved or a position's profile being saved. When a new candidate is registered or when a candidate updates his profile, the Fit Filter and AlgoFit engine calculate the fit level between the candidate and all the relevant positions. When a new position is published or when a position profile is updated, the Fit Filter and AlgoFit engine calculate the fit level between all the candidates and the new/updated position.

The Candidate Fit Filter algorithm checks first, if there is a match between the candidates's desires—the type of positions the candidate is looking for and the position's requirements, for the selected companies from the Company Fit Engine stage. If there is a match the details of the candidate is sent to the company database where it is sorted and ranked by the Candidate AlgoFit Engine.

In the next step, the Candidate AlgoFit Engine assesses the match between the candidate skills and capabilities and the requirements of the position. For each of the position's criteria, the algorithm calculates the score and multiply it by a pre-defined factor, the sum of all the scores is normalized to a score between 0-100. This score indicates how the candidate matches the position.

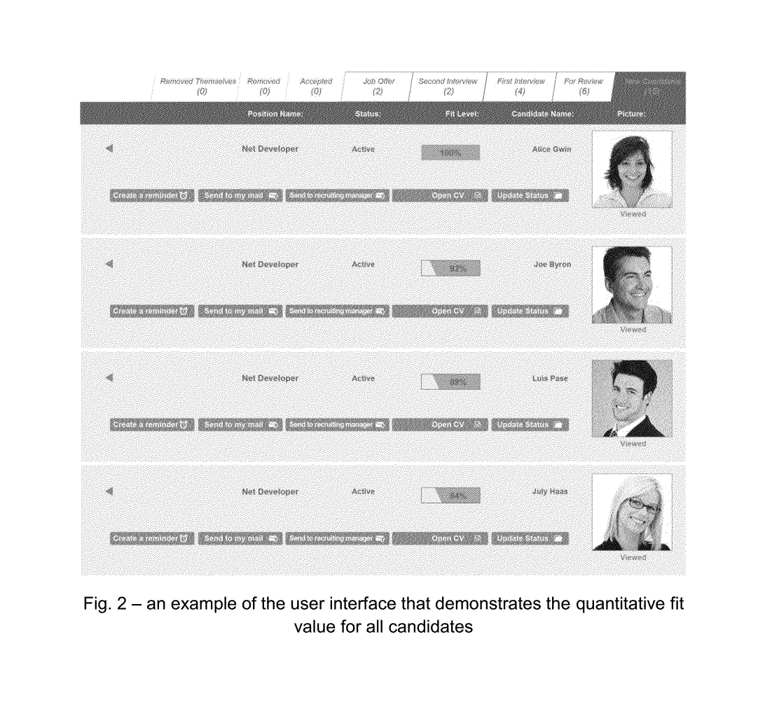

The outcome of the algorithm is a database that includes a quantitative fit value for all candidates that were applied to the position (all the candidates that passed the Candidate Fit Filter stage). This database is used by the application to provide a sorted list of candidates according to their relevancy for each position. This outcome can be illustrated in several options, and can be changed according to the company's preference; one option is demonstrated in FIG. 2.

This flow is unique because in other available solutions the candidate defines his desires and is presented only with open positions, he than needs to select each position he would like to be applied to. The candidate needs to repeat this process on a daily basis and search when a new position is opened.

In JobFit's solution the candidate is presented with a list of companies (not positions), those companies have the role or roles the candidate is looking for but may not necessarily have an open position. Because a link is established between the candidate, the company and the desired role, when a new position is opened the application knows that the candidate already approved to be applied to this company and to the new position and he is immediately applied to the position without the ongoing effort of the candidate to search for new positions.

The Fit algorithm is unique because it performs a different calculation for each position and allows the recruiter to adjust the calculation based on parameters that should be given more priority, it also can cover complex scenarios with multiple inputs (for example several degrees or years of experience).

Only candidates that pass the Fit Filter are presented to the recruiter, because the Fit Filter is based on what type of positions the candidate is looking for. Still the Fit algorithm checks if there is a match between the candidate's profile and all open positions, if there is a match it sends the candidate a proposal to extend his search criteria. If the candidate approves this proposal, he is submitted immediately to the new position.

This link between the candidate and the company enables submission of the candidate to discrete positions as well. Discrete position is a position that can't be publicly published, for example when replacing a key person in a company. Usually in those cases the candidates are found using head hunters, this process is long and expensive. The Fit Engine solution based on the Company Fit Engine creates a link between the candidate, the company and a specific role in the company. This link, together with the option to mark a position as discrete, enables the company to receive candidates immediately once the position is published. Those positions are not visible to the candidates, but the recruiter receives the candidate full information and their fit level to this position.

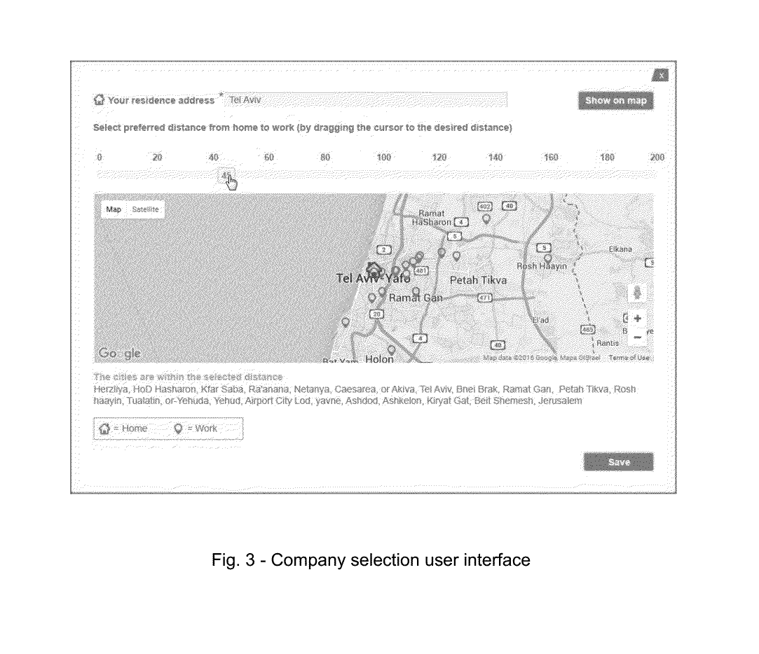

When the candidate needs to insert his acceptable distance the application can preset the data to the candidate in a simple way, implemented by an innovative user interface that uses google maps API, for example or by any other known interface. The google map centers on his address and provides indication of his address (a red house) and the location of all the companies that fit his desires and are within the distance, as can be seen in FIG. 3. On top of this, a list of cities is displayed that are within the radius of the search.

The Candidate Fit Filter algorithm checks first, if there is a match between the candidate's desires and the position's requirements. The result of this stage is a list of candidates that are passed to Candidate AlgoFit Engine.

The following examples illustrate the relevant parameters of this invention that are used by the Candidate Fit Filter, but those parameters are not limited.

For example the Fit Filter checks if there is a match between the candidate's desire and the position profile for the following parameters: company, sub field, level of seniority, job type and extent, salary range and distance.

The Fit filter checks in the first stage if the company of the specific position was selected by the candidate; Then the Fit filter checks the relevant field and the sub field, which is an expertise in a specific field, for example, but not limit to, C++ or Java are sub fields in SW field. The filter finds if there is an exact match between at least one of the sub fields from the candidate's desires and the sub fields from the position's requirements. In addition, the Fit filter checks if there is a match in the level of seniority, for example graduate, senior, manager etc. The filter finds if there is an exact match between at least one of the level of seniorities from the candidate's desires and the level of seniorities from the position's requirements. Than the Fit filter checks a match in the job type and extent field, for example full time, part time, shifts etc. The filter finds if there is an exact match between at least one of the job type and extent from the candidate's desires and the job type and extent from the position's requirements. Than the Fit filter checks that the minimum salary in the candidate's data base is lower than 1.25 times the maximum salary range in the position's database. Than the Fit filter checks if the distance between the position's location and the address of the candidate is smaller than the distance the candidate specified in his profile.

The candidate will pass the Fit Filter algorithm if there is a match for all of the parameters that were defined in the position profile, as described above.

Only candidates that passed the Fit Filter are presented to the recruiter, because there was a match between the type of positions the candidate is looking for and the position's profile.

Each one of the parameters can be defined as not mandatory to fill, in the candidate's profile or the position's profile. If the parameter was not filled by either one the Fit filter skips the relevant step.

The values of the optional parameters, for example, but not limited to, the sub field, the level of seniority, job type and extent and salary range can be taken from closed lists that are part of the database.

For each of the defined parameters there may be multiple values both in the candidate's profile and in the position's profile.

In a second stage, the candidate AlgoFit engine calculates a score value for the candidates that passed the Fit Filter algorithm, the result of the AlgoFlt stage is a sorted list of candidates that is displayed to the recruiter. Candidates that didn't pass the Fit Filter algorithm are not visible to the recruiter, because they did not choose to be applied to those types of positions. Still, for those applicants the application checks the fit level, and for candidates that received high fit level score, the application send a question to the candidate if he/she wants to be submitted to the position. The score level that above it a question will be sent to the candidate can be modified by the user.

For example, but not limited to, the AlgoFit engine calculates the score for the following parameters:
1. Field—occupation type, for example HW or SW engineer.
2. Years of Experience in Sub field—a sub field is an expertise in a field, for example VLSI or Verification are sub fields in HW field.
3. Level of Seniority—the rank of the position, for example expert, senior manager, director etc.
4. Degree and Faculty—for example BSc in computer science, MBA etc.
5. Academic Institute—for example MIT, Stanford, etc.
6. GPA—average for each degree.
7. Knowledge in Languages—for example mother tongue, good etc.
8. Distance between the candidate's address and the address of the position (some companies may have several addresses).
9. Attributes on Company's Culture—for example dynamic environment, stability, team work etc.

The algorithm can handle parameters with multiple entries. For some parameters (for example, but not limited to, sub-field, degree and faculty, level of seniority, academic institute etc.) the recruiter can provide additional information that defines if the requirement is mandatory or if it can provide advantage to the candidate. The algorithm takes this data into consideration when the score is calculated for each parameter.

For each position and for each parameter, there is a weight that defines the importance of this parameter. Those weights value are imported by default from data that was defined by the company administrator, and they can be modified by the recruiter, for each position. The option to modify the weights gives the recruiter the flexibility to modify the importance of each parameter per position. For example, but not limited to, the range of weights can be 0-5, but it can be extended to any range because the overall score is normalized by the sum of the weights. The algorithm optimizes the fields' weights according to the skills needed for a certain position, for example, the level of seniority, but the recruiter still has an option to modify those weights. For example, it may be that, the weight value of years of experience in sub filed will be lower for a new collage graduate than the weight for an experienced candidate. On the other hand the weight value of the degree and faculty will be higher for a new collage graduate than the weight for an experienced candidate. This is because the algorithm reflects how the recruiter perceives each position, new graduate may not have experience and his education is more important and this will be taken into account by changing the weight values according to the required level of seniority.

The calculated result is based on the following equation:

$$max ( \frac{Σ {K}_{i} * {S}_{i}}{Σ {K}_{i}} * \text{100,100} )$$

Where Ki is the weight of each parameter (can be defined per position) and Si is the score for each parameter.

### Calculation of the Score:

Most of the parameters are taken from sorted lists to allow calculation based on difference between the requirement of the position and the data from the candidate's profile. For example the level of seniority starts from new collage graduate, junior—up to 2 years of experience, senior—3-5 years of experience, expert—5 years of experience etc.

The flow for calculating the score is based on a difference, for a specific parameter, for example, in the following manner:

Create an Index for the Sorted List
1. Calculate the difference between all indexes from the position's values and the indexes from the candidate's profile, for the specific parameter.
   a. Value in the position's requirement that appears in the candidate's profile will result in a difference of 0 (they have the same index)
   b. If the index in the candidate's profile is lower than the index in the position's requirement the difference will be negative
   c. If the index in the candidate's profile is higher than the index in the position's requirement the difference will be positive
2. Calculate the Score
   a. If the distance is equal to 0 or 1—the score is 1
   b. If the distance is equal to −1 or 2—the score is 0.8
   c. If the distance is equal to 3—the score is 0.7
   d. If the distance is equal to −2—the score is 0.6
   e. If the distance is equal to −3 or 4—the score is 0.5
   f. For other values the score is 0

The score values (for example, 1, 0.8, 0.6 etc) can be modified by the recruiter or by any other authorized person.

The algorithm reflects how candidates are sorted by experienced recruiter. The recruiter will define values that are mandatory, for example knowledge in a specified language or minimum years of expertise is a sub field, and some values that rank the candidate higher (an advantage), for example MBA degree. On the other hand some values may be considered the same (overlapping), for example a candidate with 3-5 years of experience in Java will be ranked considered the same as a candidate with 3-5 year of experience in PHP. This is why parameters have attributes of mandatory, overlap or advantage.

The following examples are illustrative of the present invention and are not considered as limiting the invention in any way.

An example of calculating the score, using those definitions, for example for sub field, will use the following notation:
NF—Number of Fields in the position's requirements
MSF—Mandatory Sub Fields in the position's requirements
ASF—Advantage Sub Fields in the position's requirements
NSFi—Number of Sub Fields in field number i (all the sub-fields including mandatory, overlap and advantage sub-fields)

Weight of a Field—

$$\frac{{NSF}_{i}}{{\sum }_{1}^{NF} {NSF}_{i}}$$

Score for Field:

For each field that was defined in the position's requirements the algorithm calculates first the weight of the field, according to the equation above. If the field appears in the candidate's profile, the score for the field is this weight of the field, as described above, otherwise it is 0.

The overall score of the field is the sum of the scores per field.

Score for Sub Field:

Each sub field in the position and the candidate's profiles are linked with years of experience—for example more than 10 year in product marketing, 2-3 year in VLSI. The years of experience is a sorted list and can be used to calculate the score based on the difference between the values in the position's profile and the values in the candidate's profile as described above.

Sub field can be defined as mandatory, overlap (it is sufficient for the candidate to have one of those sub-fields in the candidate's profile to fulfill the requirement in the position profile), or advantage (sub-fields that provide advantage to the candidate)

Overlap Sub-Fields Score Calculation:

For each overlap sub-field that was defined in the position's requirement the algorithm checks if it appears in the candidate's profile. If it does—it calculates the score for the years of experience in the specific sub field based on difference, as described above. If it doesn't the score for this sub-field is 0. If, for example, several values were defined, for the relevant years of experience for the sub-field, in the position's profile, this calculation is performed for each one and the highest score is selected. For example the recruiter can define that it is acceptable for the candidate to have either 3-5 or 5-7 year of experience in marketing.

The overall score for overlap sub-fields is the maximum of all the scores for overlap sub-fields multiplied by

$$\frac{1}{MSF + 1} .$$

Mandatory Sub-Fields Score Calculation:

For each mandatory sub-field that was defined in the position's requirement, the algorithm checks if it appears in the candidate's profile. If it does—it calculates the score for the years of experience in the specific sub field based on difference, as described above. If it doesn't the score for this sub-field is 0. If, for example, several values were defined, for the relevant years of experience for the sub-field, in the position's profile, this calculation is performed for each one and the highest score is selected.

The overall score for mandatory sub-fields is the sum of all the scores for mandatory sub-fields multiplied by

$$\frac{1}{MSF + 1}$$

in case overlap sub-fields were defined; or

$$\frac{1}{MSF}$$

if no overlap sub-fields were defined.

Advantage Sub-Fields Score Calculation:

For each advantage sub-field that was defined in the position's requirement, the algorithm checks if it appears in the candidate's profile. If it does—it calculates the score for the years of experience in the specific sub based on difference, as described above. If it doesn't the score for this sub-field is 0. If, for example, several values were defined, for the relevant years of experience for the sub-field, in the position's profile, this calculation is performed for each one and the highest score is selected.

The overall score for advantage sub-fields is the sum of all the scores for advantage sub-fields multiplied by

$$\frac{Kf}{ASF} .$$

The factor Kf is a parameter that can be modified by the recruiter, the default value is 0.3.

The overall score for sub-field is the sum of scores of mandatory sub-fields, overlap sub-fields and advantage sub-fields

Examples of Some Fields Calculations:

The following examples are illustrative of the present invention and are not considered as limiting the invention in any way.

Score for Level of Seniority:

Level of seniority can be a sorted list that is used to calculate the score based on the difference between the candidate's highest level of seniority and the values in the position's profile. If several level of seniority were defined, in the position profile, this calculation is performed for each one and the highest score is selected.

Score for Degree and Faculty:

Degree can be a sorted list that is used to calculate the score based on the difference, as described above.

For each of the faculties that were defined in the position's profile, check if it appears in the candidate's profile. If it does, calculate the score based on the difference between the value of degrees from the candidate's profile and the values of degrees from the position's profile. If several degrees were defined, in the position profile, this calculation is repeated for each one and the highest score is selected. If the faculty is not found in the candidate's profile the score is 0. Repeat this for all faculties, the overall score for the degree and faculty is maximum of all values.

Score for Academic Institute:

For each faculty that received a score in the degree and faculty calculation, check if the academic institute that was defined in the position's profile is found in the candidate's profile, if there is a match the score is 1, otherwise 0. If several academic institutes were defined, in the position profile, this calculation is repeated for each one and the highest score is selected.

This can be, for example, a non-mandatory parameter, if the candidate didn't fill this parameter the score will be 0.5, if this parameter was not filled in the position's profile it will be ignored (the respective weight will be set to 0).

Score for GPA:

For each faculty that received a score in the degree and faculty calculation, if the candidate's GPA (Grade point average) is higher than the GPA in position's profile the score is 1. If the candidate's GPA is lower than the position's GPA—by up to 5 pts, the score is 0.8, lower by 5-10 pts the score is 0.7, lower by 10-15 pts the score is 0.6, lower by 15-20 pts the score is 0.5, otherwise 0

This can be, for example, a non-mandatory parameter, if the candidate didn't fill this parameter the score will be 0.5, if this parameter was not filled in the position's profile it will be ignored (the respective weight will be set to 0).

The pts values that are used for GPA calculation are an example and can be modified by the user.

Score for Knowledge in Languages:

Knowledge in languages can be, for example, a sorted list. For each language in the position's profile, calculate the score based on the difference between the value from the candidate's profile and the value from the position's profile.

The overall score for knowledge in languages is the sum of the above scores divided by number of languages defined in the position's profile.

This can be, for example, a non-mandatory parameter, if the candidate didn't fill this parameter the score will be 0.5, if this parameter was not filled in the position's profile it will be ignored (the respective weight will be set to 0).

Score for Attributes on Company Culture:

Count how many values from the position's profile are found in the candidate's profile and divide by the number of values in the position's profile.

Score for Distance:

Calculate the distance between the address of the candidate and the address of the position.

For distance smaller than 20 miles the score is 1, for distance between 20-40 miles the score is 0.8, for distance between 40-60 miles the score is 0.6, for distance between 60-80 miles the score is 0.4, otherwise the score is 0.2.

The scores (1, 0.8, 0.6 etc) and the distance range can be modified by the recruiter.

Graph-CV-Fit

The GraphCV provides graphic information of the fit level for the parameters defined for the specific position. This graphic data can be displayed in any known option, the possible graphics option can be changed by the recruiter preferences. The graph is divided into separate tabs, each tab provides information on a different parameter, for example the, but not limited to, the displayed data provide information on years of experience in each sub-field, distance, level of seniority, education and languages. The Y axis is the fit value of the specific requirement and the X axis is the requirement provided in the position's profile. The data that is presented in the GraphCV is a breakdown of the overall fit level that was calculated by the AlgoFit Engine.

To make the user experience effective the data is presented both quantitatively and visually using colored bars—the height of the bar and the color represent the fit level to the specific requirement. For score that is between 80%-100% the color of the bar is, for example, blue, for score that is between 60%-79% the color of the bar is, for example, orange and for values below 59% the bar is, for example, gray.

Using this visual analytic graph the competitive candidates stands out and the recruiter can identify, or eliminate, the candidates much faster.

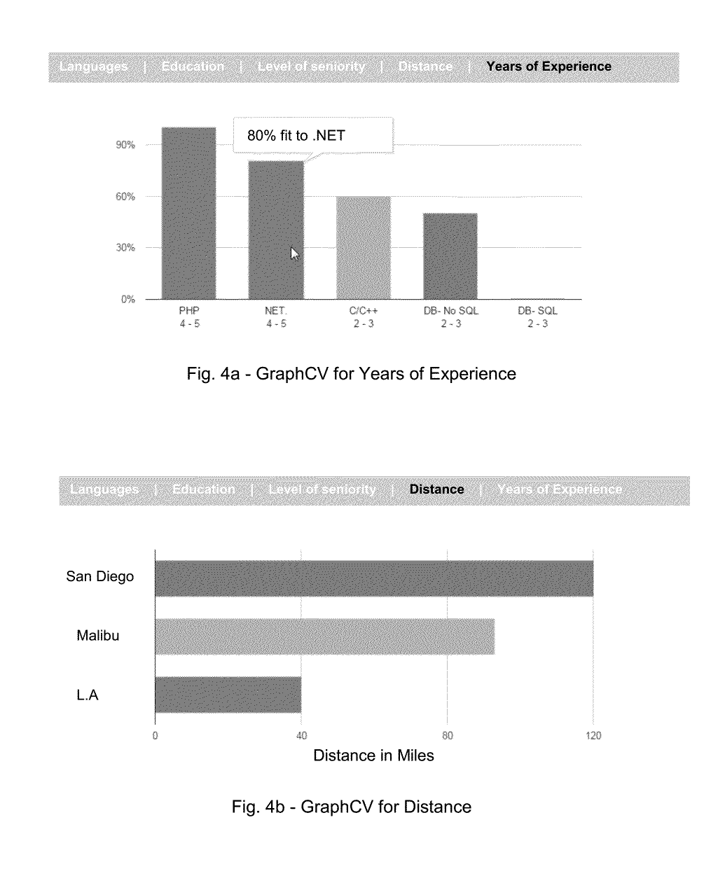

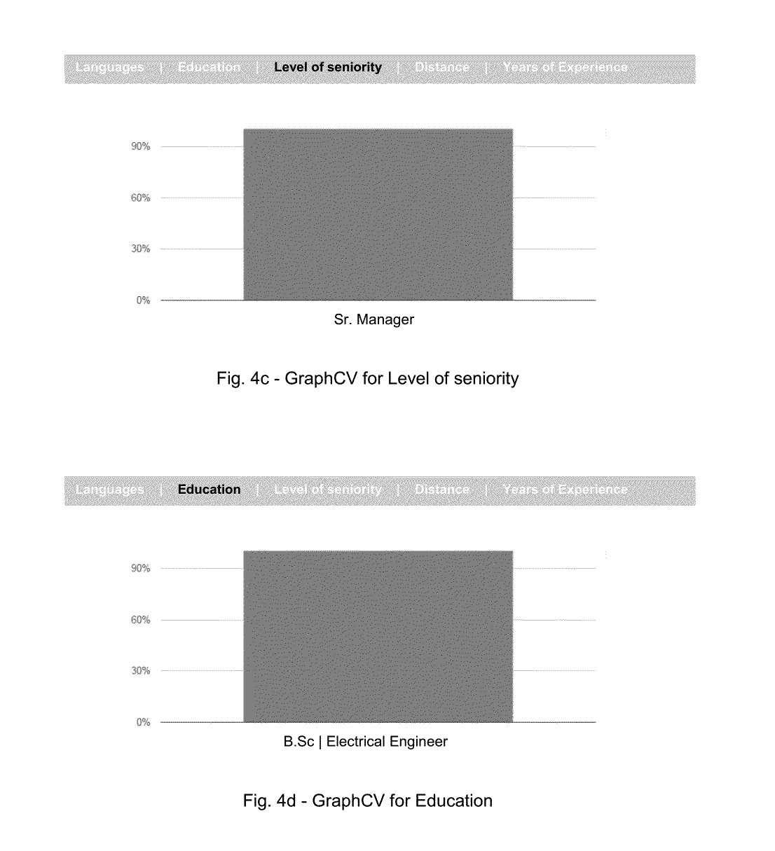

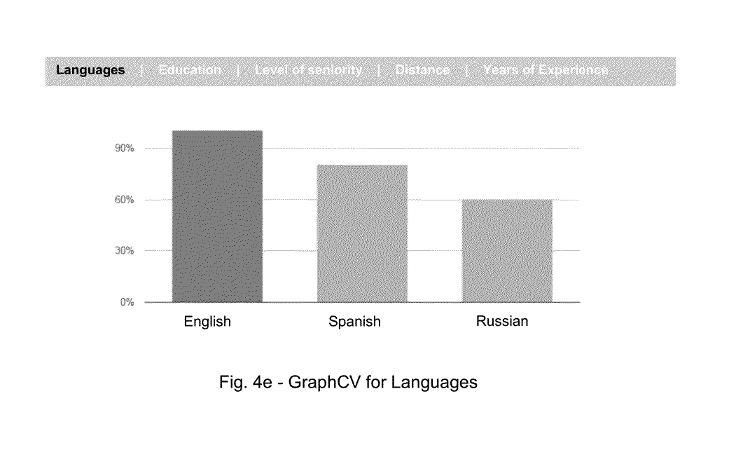

The following examples described some examples of the graphic view of the score of some fields. For example, FIG. 4a, describes a graphic view of the fit level between each sub-field from the position's profile and the candidate's profile. In this example there were 4 sub fields that were defined in the position, the Fit level (score) is calculated based on the difference between the position's requirement and the candidate's profile in the same manner as described in the AlgoFit Engine.

FIG. 4b describes a graphic view of the fit to distance. The distance between the candidate's address and the address of each office in the company, within some distance limit, is presented. The horizontal axis is the distance in miles.

FIG. 4c describes a graphic view of the Fit to Level to seniority. The score for the match between the candidate's highest level of seniority and position's parameter is presented. The x-axis is the highest level of seniority of the candidate.

FIG. 4d describes a graphic view of the Fit to Education. The score for the match between the candidate's Degree and Faculty and position's parameter is presented. The x-axis is the required degree and faculty.

FIG. 4e describes a graphic view of the Fit to Languages. The score for the match between each required languages is presented. The x-axis is the required language.

1. A Fit Engine solution for sourcing candidates to relevant position which provides immediate and automatic matching of the right candidate to the right position in the right company.

2. The Fit Engine of claim 1 wherein the company defines the parameters for a specific position, the candidate enters his desires and profile parameters, the data is analyzed and sorted by the Fit Filter and the Fit Algorithm and the application provides a ranked and stored list of the most relevant Candidates.

3. The Fit Engine of claim 2 wherein the parameters can be, field, sub field, level of seniority, job type and extent, salary range, years of experience, distance, degree and faculty, academic institute, GPA, knowledge in languages and attributes on company's culture.

4. The web Fit Engine of claim 2 wherein the company can determine some parameters that are more important than others.

5. The web Fit Engine of claim 2 wherein the company can define for each parameter a different weight that defines the importance of this parameter.

6. The Fit Engine of claim 1 where there is no need for Placement Company or a recruiter to sort the candidates.

7. The Fit Engine of claim 1 wherein the candidate's information is available to each position, at any time it is published and the candidate can be available to a position that is already published and to positions that will be published in the future without any intervention from the candidate.

8. The Fit Engine of claim 1 in which the candidates select specific companies and specific roles, and the application finds out a fit between the candidate's skills and the company's needs.

9. The Fit Engine of claim 3 in which the application provides a ranked list of the candidates.

10. The Fit Engine of claim 1 which submits a proposal to the candidate to extend the candidate's search criteria and select additional roles that were not defined in his desires, in case the application finds a match.

11. The Fit Engine of claim 1 which enables submission of candidates to discreet positions, when it finds a match.

12. The Fit Engine of claim 1 which illustrates the candidate his preferred radius of working area, by some illustrating engine, which centers on his address and provides indication of his address and indication of the location of all the companies that fit his desires and are within his desired distance.

13. The Fit Engine of claim 1 wherein the data is illustrated as a graphic interface (GraphCV Fit) of the fit level between each of the position's parameters and the candidate's profile.

14. In Fit Engine solution of claim 1, which established a link between the candidate, the company and the desired role, wherein the candidate is presented with a list of companies, those companies have the roles the candidate is looking for but may not necessarily have an open position. Therefore, when a new position is opened he is immediately applied to the position without the ongoing effort of the candidate to search for new positions.

15. A Fit Engine solution for sourcing candidates to relevant positions which provides immediate and automatic matching of the right candidates to the right position in the right company; wherein the company defines the parameters for a specific position, the candidate enters his desires and profile parameters, the data is analyzed and sorted by the Fit Filter and the Fit Algorithm and the application provides a ranked and stored list of the most relevant Candidates. The candidate's information is available to each position, at any time it is published and the candidate can be available to a position that is already published and to positions that will be published in the future without any intervention from the candidate.

16. A process that finds and ranks adequate candidates for each position or company, based on the specification of the position and the skills and desires of the candidate.

17. The process of claim 16 which by using a Fit Filter and a Fit Algorithm engine, combines the company's definitions parameters for a specific position, and the candidate's desire and profile parameters, analyzed and sort them and provides a ranked list of the most relevant candidates.
